(19) United States
(12) Patent Application Publication
(10) Pub. No.: US 2017/0034024 A1
(43) Pub. Date: Feb. 2, 2017

(54) PARAMETRIC MODEL FOR VIDEO SCORING

(71) Applicant: Futurewei Technologies, Inc., Plano, TX (US)

(72) Inventors: Kamalaharan Dushyanthan, Metuchen, NJ (US); Dong-Qing Zhang, Branchburg, NJ (US); Mark Newbury, Hillsborough, NJ (US)

(21) Appl. No.: 14/810,908

(22) Filed: Jul. 28, 2015

(51) Int. Cl. H04L 12/26; G11B 27/36; H04L 29/06

(52) U.S. Cl. CPC H04L 43/0852; H04L 65/4069; G11B 27/36

(57) ABSTRACT

A method comprises playing at a device, over a first time period, a video stream having a bit rate. The method further comprises determining a count of stalls in the playing of the video stream; determining, based on the count of stalls and the bit rate, a score for the video stream; and providing, to a server device, the score.

### TECHNICAL FIELD

Embodiments of the present disclosure relate generally to data processing and, more particularly, but not by way of limitation, to a method and system for generating a mean opinion score using a parametric quality of experience model.

### BACKGROUND

Conventionally, mean opinion scores (MOS) for a quality of experience for viewings of a video are generated by polling users after each user has viewed the video. Conventional automated video quality measures do not closely align with the MOS scores generated by users.

### SUMMARY

In some example embodiments, what is disclosed is a method comprising: playing at a device, over a first time period, a video stream having a bit rate; determining a count of stalls in the playing of the video stream; determining, based on the count of stalls and the bit rate, a score for the video stream; and providing, to a server device, the score.

In some example embodiments, what is disclosed is a system comprising: a memory storing instructions; and a processor coupled to the memory, wherein when the processor executes the instructions, the instructions instruct the processor to: monitor play, over a first time period, of a video stream having a bit rate; determine a count of stalls in the playing of the video stream; determine, based on the count of stalls and the bit rate, a score for the video stream; and provide, to a device, the score.

In some example embodiments, what is disclosed is a computer program product comprising computer executable instructions stored on a non-transitory computer-readable medium that, when executed by a processor, cause the processor to perform operations comprising: playing at a device, over a first time period, a video stream having a bit rate; determining a count of stalls in the playing of the video stream; determining, based on the count of stalls and the bit rate, a score for the video stream; and providing, to a server device, the score.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system suitable for generating a video mean opinion score using a parametric quality of experience model, according to some example embodiments.

FIG. 2 is a block diagram illustrating modules of a computer system suitable for generating a video mean opinion score (MOS) using a parametric quality of experience model, according to some example embodiments.

FIG. 3 shows two graphs of the impact of a rebuffering percentage on video MOS, according to some example embodiments.

FIG. 4 shows two graphs of the impact of a rebuffering frequency on video MOS, according to some example embodiments.

FIG. 5 shows two graphs of the impact of an initial buffering delay on video MOS, according to some example embodiments.

FIG. 6 shows a graph of the impact of a frame rate on video MOS, according to some example embodiments.

FIG. 7 shows a graph of the impact of a memory effect on video MOS, according to some example embodiments.

FIG. 8 is a flow diagram illustrating operations of a computer system suitable for generating a video MOS, according to some example embodiments.

FIG. 9 is a flow diagram illustrating operations of a computer system suitable for generating a video MOS, according to some example embodiments.

FIG. 10 is a flow diagram illustrating operations of a computer system suitable for generating a video MOS, according to some example embodiments.

FIG. 11 is a flow diagram illustrating operations of a computer system suitable for generating a video MOS, according to some example embodiments.

FIG. 12 is a flow diagram illustrating operations of a computer system suitable for utilizing a video MOS, according to some example embodiments.

FIG. 13 is a block diagram illustrating an example of a software architecture suitable for a generating a video MOS, according to some example embodiments.

FIG. 14 illustrates a diagrammatic representation of a machine in the form of a computer system within which a set of instructions may be executed for causing the machine to generate a video mean opinion score using a parametric quality of experience model, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A video stream is transmitted from a server to one or more clients. To reduce stalls in the playback of the video stream, video players commonly use buffers to store a portion of the video. A larger buffer reduces the probability of experiencing stalls, but increases the delay time before playback begins, to allow the buffer to fill. For example, if the buffer were the size of an entire video, the entire video would be downloaded into the buffer before playback could begin, and the video would play without stalls. As another example, if a buffer of size 0 were used, each frame of the video would play as soon as it was received, but playback would halt whenever the bandwidth between the server and the video player fell below the threshold needed to support playback. When a non-trivial buffer (i.e., a buffer of a size between 0 and the size of the video) is used, playback is halted whenever the amount of data remaining in the buffer falls below a threshold (e.g., when no frames remain to be played) and playback resumes when the amount of data in the buffer exceeds a second threshold (e.g., when five seconds of video are stored or when the buffer is full). The delay from initial buffering and the delay from rebuffering events impact the quality of the video-viewing experience for the user. To reduce the initial buffering delay and the probability of rebuffering events, lower quality video may be transmitted (e.g., video having a lower frame rate, a lower resolution, or a lower bit rate (e.g., resulting from higher compression)). The use of lower quality video also impacts the quality of the video-viewing experience for the user. Measuring the quality of the viewing experience through video mean opinion scores (VMOS) allows video providers to determine the appropriate values for attributes such as the buffer size, the frame rate, the resolution, and the bit rate.

Generating VMOS through the polling of viewers is associated with a number of challenges, one or more of which may be overcome through the use of methodologies described herein. For example, a VMOS generated through polling cannot be obtained without the cooperation of the viewers and cannot be obtained until a sufficient number of viewers have completed the poll. Automated generation of a score predicted to have a high correlation with the VMOS may be achieved without viewer cooperation and may include most or all viewers without additional difficulty. A parametric VMOS algorithm is a generalized algorithm for determining VMOS that can be customized through the use of parameters.

During a calibration phase, parameters of a parametric VMOS algorithm are determined by fitting curves generated by the VMOS algorithm to user-generated data points. A particular combination of parameters is termed a “profile.” Different profiles will, in most cases, generate different curves. During an evaluation phase, the calibrated parametric VMOS algorithm determines the VMOS of the video and provides the resulting VMOS. The generated VMOS may be used to adjust settings of the video provider, the video player, or both, to improve the expected VMOS for future videos; additionally, a collection of generated VMOS may serve as a useful, continuing indicator to the video service provider regarding the level of video quality experienced by their users.

The resulting VMOS may include a number of discrete components, dependent on technical aspects of the video stream. Analysis of the discrete components, in conjunction with cost estimates for improving the discrete components, yields cost-effective suggestions for improving the quality of the video stream. Accordingly, a video provider can implement an automatic system to provide at least a minimum VMOS at a lowest price, provide a maximum VMOS for a fixed price, or any suitable combination thereof.

The generated VMOS is based on one or more impact factors. The impact factors may be based on one or more of a rebuffering time, a rebuffering frequency, a frame rate, a memory effect, a start delay, a connection failure, an optimal frame rate, a bit rate, or other factors associated with the video data or playback of the video. The impact factors may be summed, multiplied together, or any suitable combination thereof.

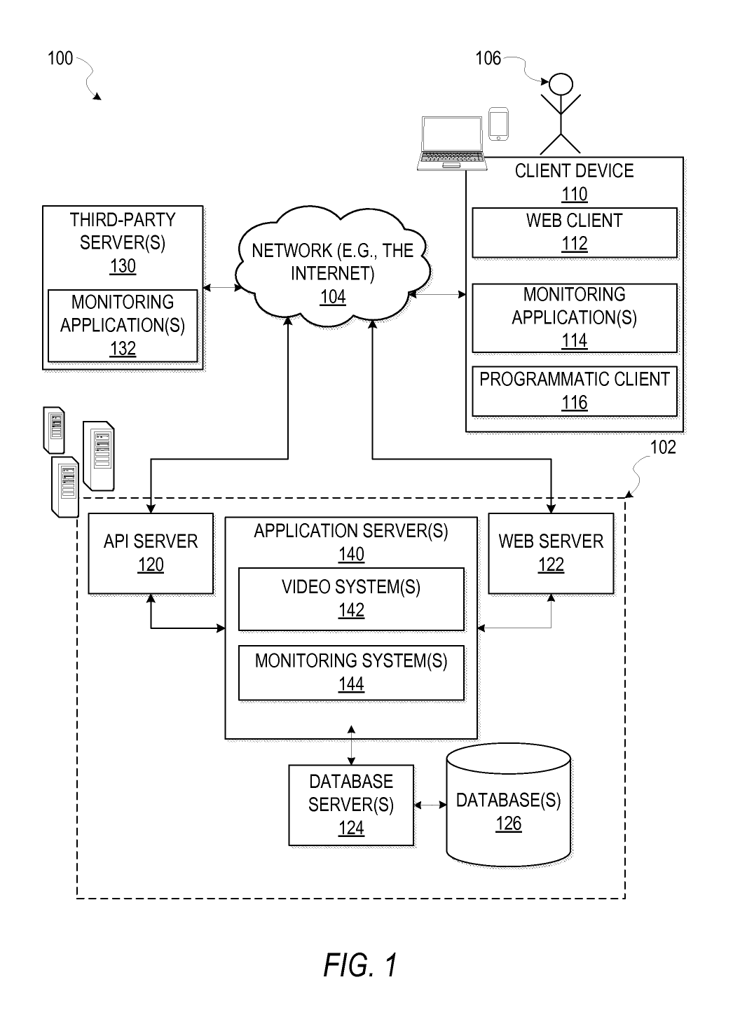

With reference to FIG. 1, an example embodiment of a high-level client-server-based network architecture 100 is shown. The figure (and subsequent figures) disclose a system and method that generates a video MOS based on characteristics of the video and characteristics of the playback of the video. The system and method advantageously provides an automated way of generating approximations of user VMOS values without requiring user input. A networked system 102 provides server-side functionality via a network 104 (e.g., the Internet or wide area network (WAN)) to one or more client devices 110. FIG. 1 illustrates, for example, that the client device 110 can include a web client 112 (e.g., a browser, such as the Internet Explorer® browser developed by Microsoft® Corporation of Redmond, Wash. State), one or more monitoring applications 114, and a programmatic client 116 executing on the client device 110.

The client device 110 may comprise, but is not limited to, a mobile phone, desktop computer, laptop, portable digital assistant (PDA), smart phone, tablet, ultra book, netbook, multi-processor system, microprocessor-based or programmable consumer electronics, or any other communication device that a user may utilize to access the networked system 102. In some embodiments, the client device 110 may comprise a display module (not shown) to display information (e.g., in the form of user interfaces). The client device 110 may be a device of a user that is used to monitor or display one or more videos. In one embodiment, the networked system 102 is a network-based system for providing videos and assessing video quality. One or more portions of the network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, a messaging application, an electronic mail (email) application, a video playback application, a video quality monitoring application, and the like. In some embodiments, if the video quality monitoring application is included in a given client device 110, then this application is configured to locally provide the user interface and at least some of the functionalities with the application configured to communicate with the networked system 102, on an as needed basis, for data or processing capabilities not locally available. Conversely if the video playback application is not included in the client device 110, the client device 110 may use its web browser to access the video quality monitoring system (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 host one or more video systems 142 and monitoring systems 144, each of which comprises one or more modules or applications and each of which may be embodied as hardware, software, firmware, or any combination thereof. The application servers 140 are, in turn, shown to be coupled to one or more database servers 124 that facilitate access to one or more information storage repositories or databases 126. In an example embodiment, the databases 126 are storage devices that store information to be accessed by the video systems 142 and the monitoring systems 144.

Additionally, one or more monitoring applications 132, communicating with or integrated into third-party servers 130, are shown as having programmatic access to the networked system 102 via the programmatic interface provided by the API server 120. In embodiments in which the monitoring application 114 on the client device 110 is unavailable, the third-party server 130 may be used to approximate the experience of the user 106 on the client device 110. For example, data transmitted from the networked system 102 to the third-party server 130 may have comparable delays to data transmitted from the networked system 102 to the client device 110. Accordingly, monitoring application 132 can simulate the receipt, consumption of data, and stalls in playback occurring on the client device 110. The monitoring application 132 can either generate a video MOS and transmit the video MOS to the networked system 102 or transmit lower-level data to the networked system 102, to be stored in the database 126 by the database server 124 for processing by the monitoring system 144 in generating a video MOS for one or more videos provided by the video system 142.

The video systems 142 provide streaming video data to the users 106 that access the networked system 102, that access the third-party servers 130, that access the monitoring systems 144, or that access any suitable combination thereof. The monitoring systems 144 may provide feedback to the video systems 142, causing the video systems 142 to adjust the manner in which the streaming video is provided. While the video system 142 and monitoring system 144 are shown in FIG. 1 to both form part of the networked system 102, it will be appreciated that, in alternative embodiments, each system 142 and 144 may form part of a communication or control service that is separate and distinct from the networked system 102. In some embodiments, the monitoring systems 144 form part of the video system 142.

Further, while the client-server-based network architecture 100 shown in FIG. 1 employs a client-server architecture, the present inventive subject matter is, of course, not limited to such an architecture, and could equally well find application in a distributed, or peer-to-peer, architecture system, for example.

The web client 112 may access the various video and monitoring systems 142 and 144 via the web interface supported by the web server 122. Similarly, the programmatic client 116 accesses the various services and functions provided by the video and monitoring systems 142 and 144 via the programmatic interface provided by the API server 120.

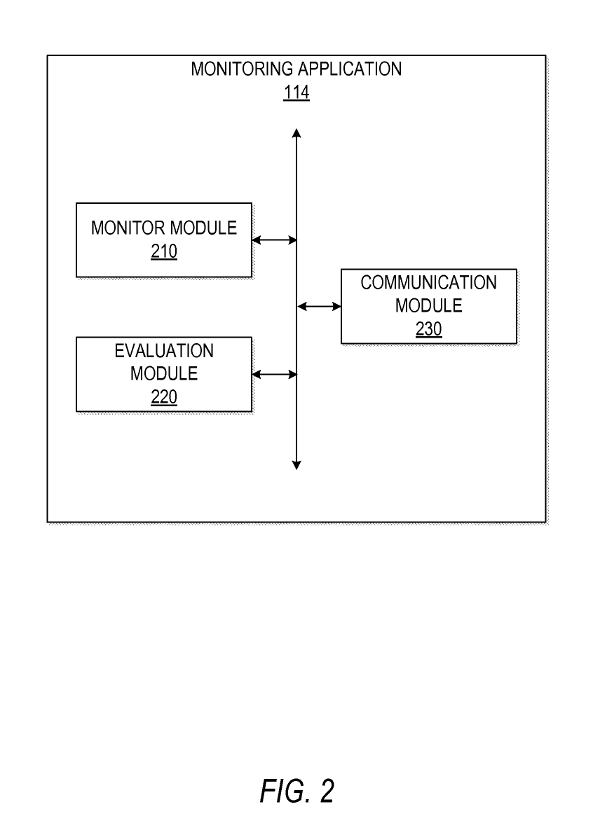

FIG. 2 is a block diagram illustrating modules of a monitoring application 114 suitable for generating a video mean opinion score using a parametric quality of experience model, according to some example embodiments. As shown in FIG. 2, the monitoring application 114 includes a monitor module 210, an evaluation module 220, and a communication module 230.

The monitor module 210 monitors the quality of a video stream received on the client device 110. For example, the number of stalls in the receiving of the video, the count of the stalls in the receiving of the video, the amount of time between an initial request for the video and the beginning of playback of the video, the bit rate of the received video, the frame rate of the video, the duration of the last uninterrupted portion of the video, and other quality metrics may be monitored.

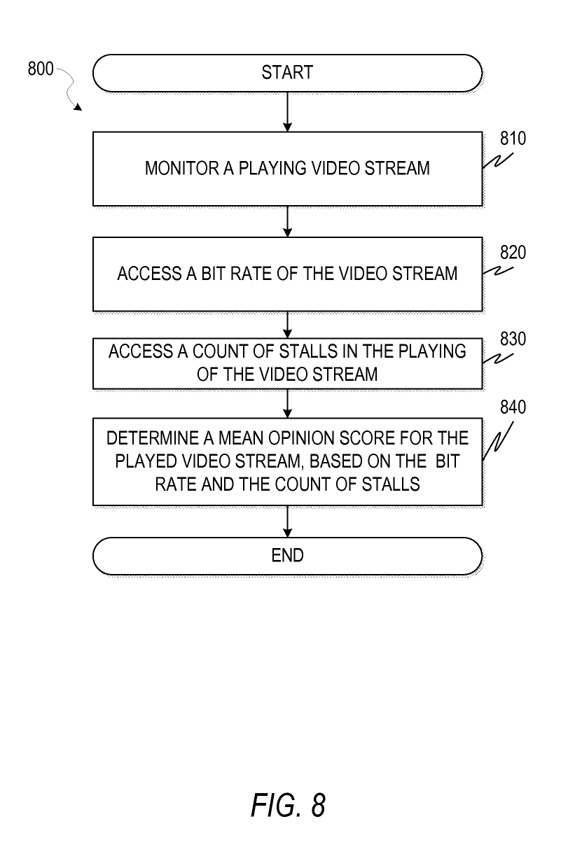

The evaluation module 220 determines a VMOS for the received video stream based on the data gathered by the monitor module 210. For example, the VMOS may be higher when the number of stalls is low, lower when the initial delay is high, higher when the bit rate is high, or any suitable combination thereof. Additional details regarding evaluation techniques are described below, with respect to FIGS. 8-11.

The communication module 230 sends data to and receives data from other systems (e.g., the systems shown in FIG. 1). For example, the communication module 230 may receive data from the video system 142 and send data to the monitor module 210. In some example embodiments, communications from the communication module 230 cause the display of a user interface on the client device 110. For example, the communication module 230 may receive a web page for a web browser of the client device 110. The web browser parses the web page to generate a user interface on the client device 110, for display to the user 106.

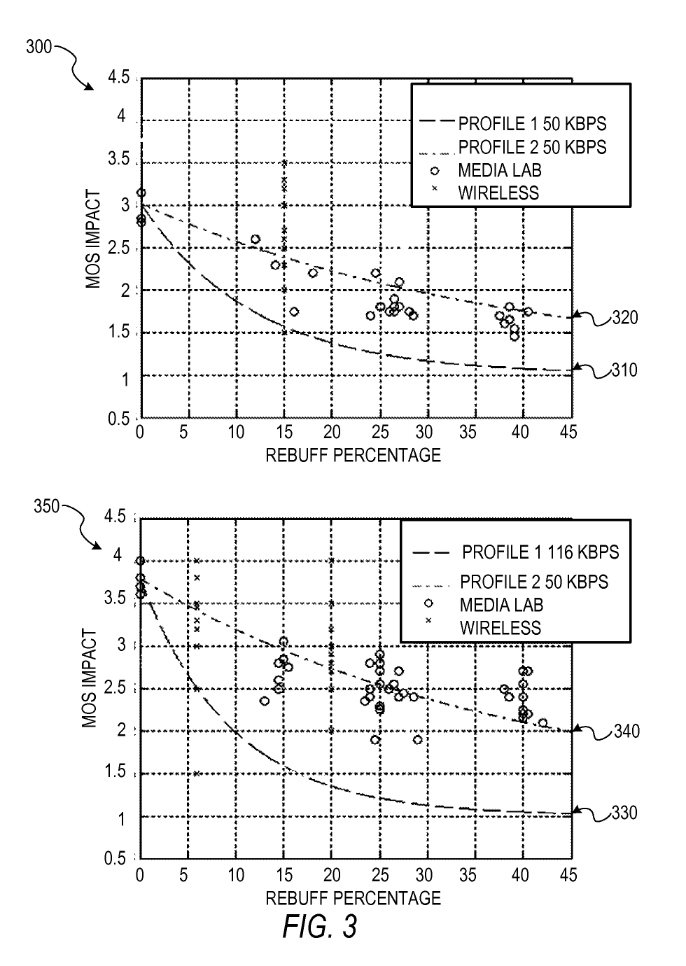

FIG. 3 shows two graphs (300 and 350) of the impact of a rebuffering percentage on video MOS that illustrate example data suitable for setting parameters in a parametric quality of experience model for generating a video mean opinion score, according to some example embodiments. In the graph 300, two curves are shown, one for each of two profiles at 50 kilobits per second (kbps). Using the same bit rate for both profiles for the comparison ensures that differences in MOS are not caused by differences in video quality due to differing bit rates.

Curve 310 shows the MOS impact of different rebuffering percentages for the first profile, while curve 320 shows the MOS impact of the different rebuffering percentages for the second profile. The graph 300 also shows two sets of MOS data collected from human viewers of videos: a first set of data, marked with circles, from a media lab, and a second set of data, marked with x's, from a wireless network. As can be seen in the graph 300, the curve 320 for the second profile matches the two observed sets of data more closely than the curve 310 for the first profile. Accordingly, at 50 kbps, the parameters used for the generation of the second profile may be preferred over the parameters used for the generation of the first profile.

The graph 350 also shows two curves, showing the MOS impact of different rebuffering percentages for the same two profiles at 116 kbps. The graph 350 also shows two sets of MOS data: a first set of data, marked with circles, from the media lab, and a second set of data, marked with x's, from the wireless network. As can be seen in the graph 350, the curve 330 for the second profile matches the two observed sets of data more closely than the curve 340 for the first profile. Accordingly, at 116 kbps, the parameters used for the generation of the second profile may be preferred over the parameters used for the generation of the first profile. In various example embodiments, various numbers of profiles are used and tested with respect to varying independent variables. The parameterization of the VMOS may be based on minimizing an error value across the tested profiles and the ranges of the independent variables.

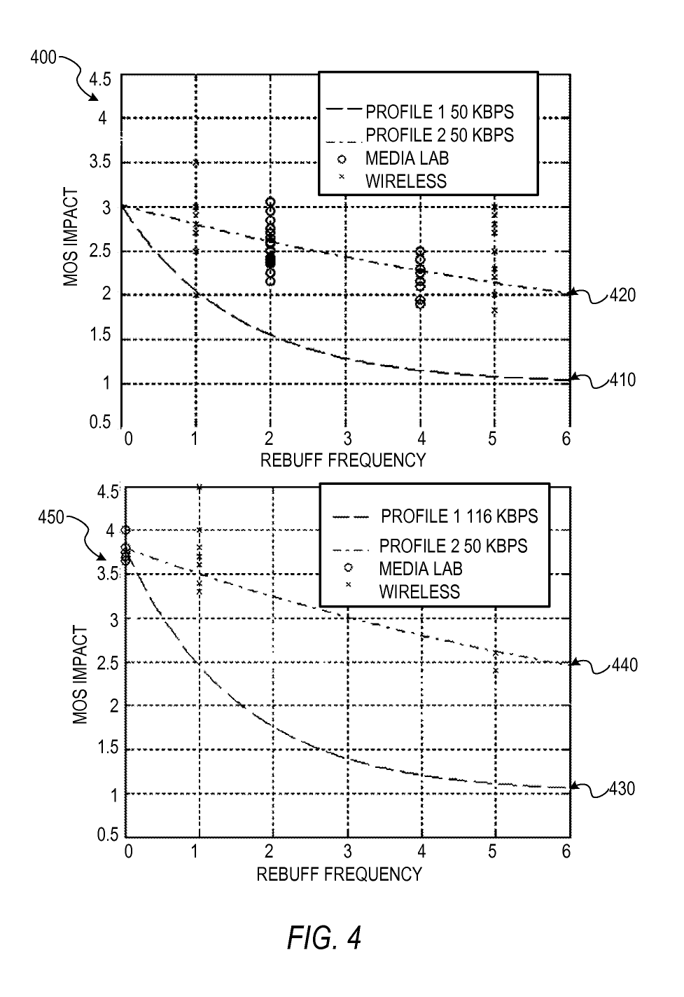

FIG. 4 shows two graphs (400 and 450) of the impact of a rebuffering frequency on video MOS, according to some example embodiments. In the graph 400, two curves are shown, one for each of two profiles at 50 kbps. Curve 410 shows the MOS impact of different rebuffering percentages for the first profile, while curve 420 shows the MOS impact of the different rebuffering percentages for the second profile. The graph 400 also shows two sets of MOS data collected from human viewers of videos: a first set of data, marked with circles, from a media lab, and a second set of data, marked with x's, from a wireless network. As can be seen in the graph 400, the curve 420 for the second profile matches the two observed sets of data more closely than the curve 410 for the first profile. Accordingly, at 50 kbps, the parameters used for the generation of the second profile may be preferred over the parameters used for the generation of the first profile.

The graph 450 also shows two curves, showing the MOS impact of different rebuffering frequencies for the same two profiles at 116 kbps. The graph 450 also shows two sets of MOS data: a first set of data, marked with circles, from the media lab, and a second set of data, marked with x's, from the wireless network. As can be seen in the graph 450, the curve 440 for the second profile matches the two observed sets of data more closely than the curve 430 for the first profile. Accordingly, at 116 kbps, the parameters used for the generation of the second profile may be preferred over the parameters used for the generation of the first profile.

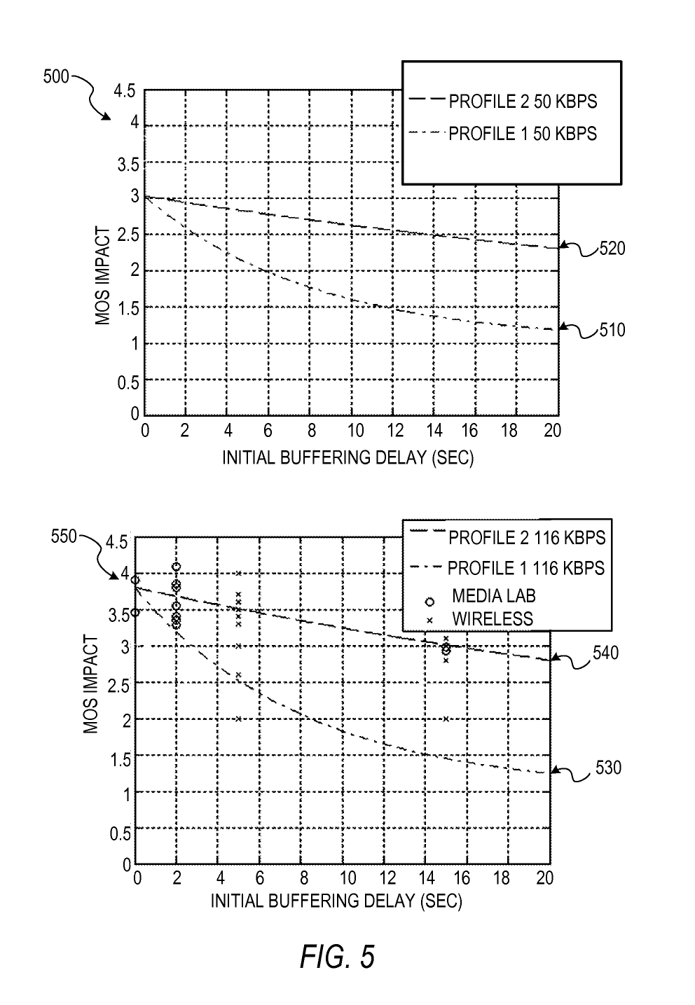

FIG. 5 shows two graphs (500 and 550) of the impact of an initial buffering delay on video MOS for different profiles at different data rates, according to some example embodiments. The graph 500 shows curves 510 and 520 at 50 kbps and the graph 550 shows curves 530 and 540 at 116 kbps. In the examples shown, the profiles of FIG. 5 are the same as the profiles of FIGS. 3 and 4.

In addition to the curve 530 and the curve 540, the graph 550 also shows two sets of MOS data: a first set of data, marked with circles, from the media lab, and a second set of data, marked with x's, from a wireless network. As can be seen in the graph 550, the curve 530 for the second profile matches the two observed sets of data more closely than the curve 540 for the first profile. Accordingly, at 116 kbps, the parameters used for the generation of the second profile may be preferred over the parameters used for the generation of the first profile.

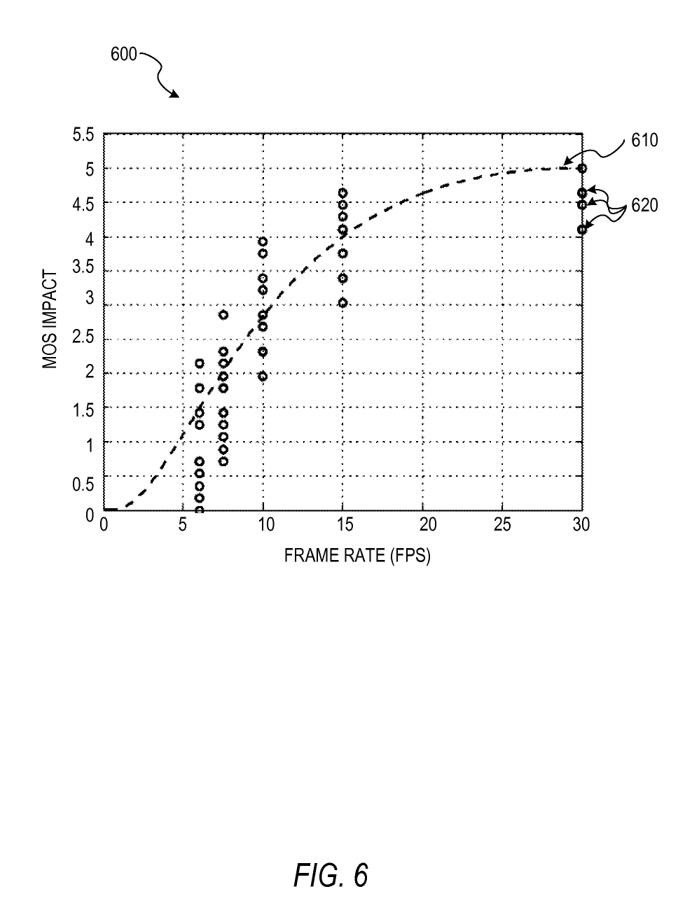

FIG. 6 shows a graph 600 of the impact of a frame rate on video MOS, according to some example embodiments. The graph 600 shows curve 610, showing a generated MOS value based on the frame rate. The graph 600 also shows values 620 (marked by circles), providing data to which parameters used to generate the curve 610 are adjusted to fit.

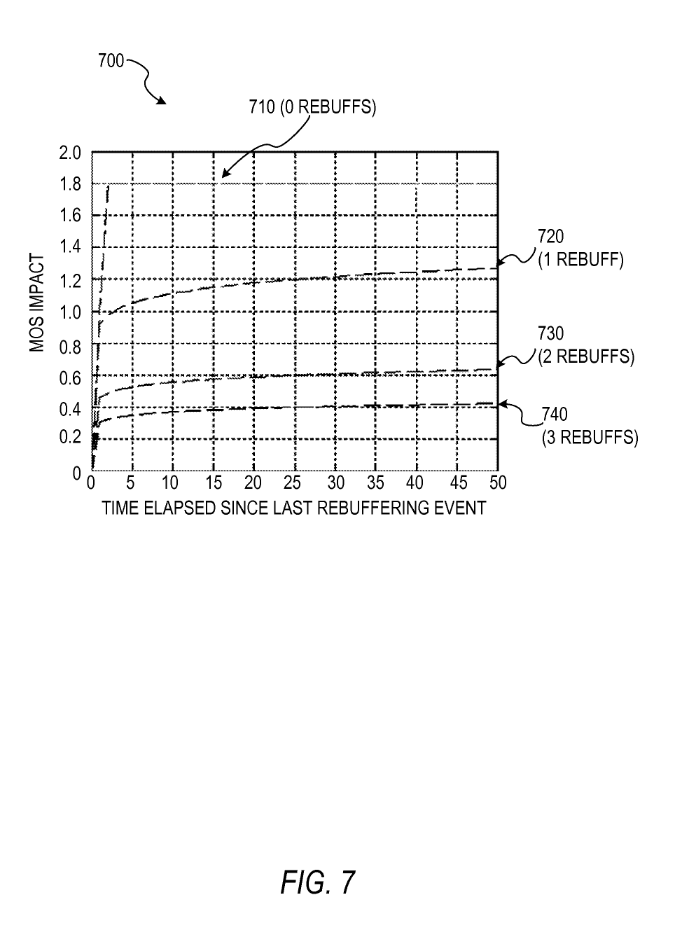

FIG. 7 shows a graph 700 of the impact of a memory effect on video MOS, according to some example embodiments. When determining mean opinion scores from user feedback, it has been observed that even when the number and duration of rebuffering events are the same, the MOS is higher when the last rebuffering event occurs earlier in the playback of the video. That is, there is a “memory effect,” in which users remember the rebuffering events more strongly when they occur closer to the time the opinion score is provided. Accordingly, a memory effect factor in the determination of the video MOS provides higher scores when the last rebuffering event occurs earlier in the media playback and provides lower scores when the last rebuffering event occurs nearer to the end of the media playback.

The graph 700 includes curves 710, 720, 730, and 740 that show the impact of the memory effect for different numbers of rebuffering events. The curve 710 shows an MOS score of 1.8 when no rebuffering occurs. The curve 720 shows that if only one rebuffering event occurs, and if it occurs within a few seconds of the end of the video, the MOS will be less than 1. However, if that single rebuffering event occurs more than 45 seconds before the end of the video, the MOS will be above 1.2. As the number of rebuffering events increases, the MOS values drop, as can be seen by the relative positions of curves 710, 720, 730, and 740. Each of the curves 720-740 show the memory effect, in that, for any non-zero fixed number of rebuffering events, the MOS value is lower when the last rebuffering event was closer to the end of the video. Accordingly, the parameters for a memory effect-dependent portion of the VMOS generation algorithm can be set based on the shapes of the curves 720-740.

FIG. 8 is a flow diagram illustrating operations in a process 800 of a computer system suitable for generating a video MOS, according to some example embodiments. By way of example and not limitation, the operations of the method 800 are described as being performed by the modules of FIG. 2.

In operation 810, the monitor module 210 monitors a playing video stream. For example, a video stream may be received and played by a video playback application. The monitoring may be performed by the video playback application, a plug-in to a video playback application, an operating system running the video playback application, a stand-alone application, a network driver, or any suitable combination thereof. The monitoring of the received video stream may include tracking a time at which the video stream was requested, a time at which playback began, a time at which playback completed, a number of stalls of the playback, a duration of the stalls of the playback, a bit rate of the received video stream, a frame rate of the played video stream, or any suitable combination thereof.

In operation 820, the evaluation module 220 accesses a bit rate of the video stream. For example, the video stream may have been encoded at 2,000 kbps. The evaluation module 220 also accesses a count of stalls in the playing of the video stream in operation 830. For example, network congestion may cause a buffer of video data to empty during playback at which time playback is halted to allow the buffer to refill. Network congestion may be caused by limits in the bandwidth supported by the physical connections between the client and server, by high data transmissions between other computers sharing network infrastructure with the client and the server, by the server attempting to provide video data to an excessive number of clients, such that the total data rate for all the streams is greater than the amount of outgoing bandwidth from the server, by the client attempting to access multiple data streams, which, in the aggregate, exceed the incoming bandwidth of the client, by routing errors, by the failure of intermediate devices in the network between the client and server, or by various combinations thereof. Each time playback halts, a count of the stalls is incremented.

The evaluation module determines a MOS for the received video stream based on the bit rate and the count of stalls in operation 840. For example, a score for the bit rate and a score for the stall count may be multiplied together and used to generate the MOS for the video stream.

In some example embodiments, the score for the bit rate is generated from equations of the form:

$$\begin{matrix}{I}_{Ofr} = {v}_{1} - \frac{{v}_{1}}{1 + ( \frac{{Br}_{v}}{{v}_{2}} ) {v}_{3}} & ( 1 ) \\ 0 \leq {I}_{Ofr} \leq 4 & ( 2 )\end{matrix}$$

In the above equation, I_{Ofr} is the score derived from the bit rate. v₁, v₂, and v₃ are parameters of the model. Brᵥ is the bit rate of the original video property. Thus, I_{Ofr} provides a score for the video based on the original bit rate, but does not take into account any impact or disturbance during the video delivery.

The score for the rebuffering frequency may be determined using equations of the form:

$$\begin{matrix}{I}_{RF} = {e}^{- λ ( {R}_{F} - {R}_{F 0} )} + {V}_{r} & ( 3 ) \\ λ = {v}_{8} + {v}_{9} {Br}_{v} & ( 4 ) \\ {V}_{r} = F ( {v}_{10} + {v}_{11} {Br}_{v} ) & ( 5 ) \\ {R}_{F 0} = \frac{log ( 1 - {V}_{r} )}{λ} & ( 6 ) \\ F ( t ) = \frac{2 {v}_{18}}{1 + {e}^{- {v}_{19} t}} - {v}_{18} & ( 7 ) \\ 0 \leq {V}_{r} \leq 1 & ( 8 ) \\ 0 < {v}_{18} < 1 & ( 9 ) \\ {v}_{19} > 0 & ( 10 )\end{matrix}$$

In the above equations, I_{RF} is the score derived from the bit rate. v₈, v₉, v₁₀, v₁₁, v₁₈, and v₁₉ are parameters of the model. Brᵥ is the bit rate of the original video. R_{F} is the count of stall events.

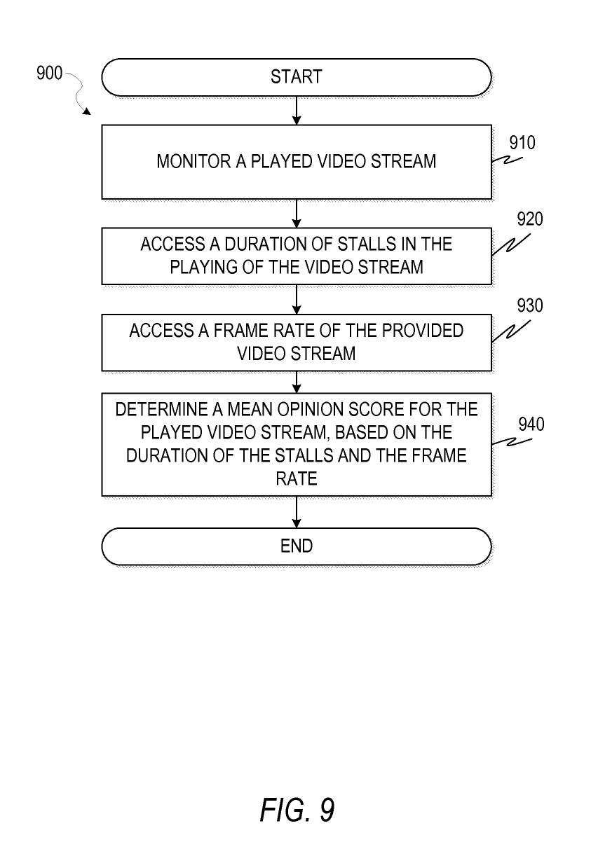

FIG. 9 is a flow diagram illustrating operations of a computer system implementing a process 900 suitable for generating a video MOS using a parametric quality of experience model, according to some example embodiments. By way of example and not limitation, the operations of the method 900 are described as being performed by the modules of FIG. 2. In operation 910, the monitor module 210 monitors a playing video stream, as previously discussed.

In operation 920, the evaluation module 220 accesses a duration of the stalls in the video stream (e.g., the counted stalls accessed in operation 830). For example, a first playback having one 30-second stall and a second playback having thirty one-second stalls would both have the same duration of stalls (thirty seconds).

The evaluation module 220 accesses a frame rate of the provided video stream in operation 930. In operation 940, the evaluation module 220 determines a mean opinion score for the received video stream based on the duration of the stalls, the frame rate, or both. MOS factors based on the duration of the stalls and the frame rate may be combined by multiplying them together. The MOS may be further based on the bit rate of the video or other quality factors. In some example embodiments, the MOS score is generated using equations of the form:

$$\begin{matrix}{I}_{rebuf} = {e}^{- λ ( {R}_{p} - {R}_{p 0} )} + {V}_{r} & ( 11 ) \\ 0 \leq {V}_{r} \leq 1 & ( 12 ) \\ λ = {v}_{4} + {v}_{5} {Br}_{v} & ( 13 ) \\ {V}_{r} = F ( {v}_{6} + {v}_{7} {Br}_{v} ) & ( 14 ) \\ {R}_{p 0} = \frac{log ( 1 - {V}_{r} )}{λ} & ( 15 ) \\ {I}_{FR} = {e}^{- \frac{{( {lnFr}_{v} - {lnO}_{fr} )}^{2}}{2 {D}_{{Fr}_{v}}^{2}}} & ( 16 ) \\ {D}_{{Fr}_{v}} = {v}_{16} + {v}_{17} {Br}_{v} & ( 17 )\end{matrix}$$

In the above equations, I_{rebuf} is the score derived from the duration of stalls and I_{FR} is the score derived from the frame rate. v₄, v₅, v₇, v₁₆, and v₁₇ are parameters of the model. Brᵥ is the bit rate of the original video. F is defined above with respect to the operation 840. Rₚ is the duration of the stalls, expressed as a percentage of the entire playback time. For example, if a one-minute video experienced 15 seconds of stalls, the entire playback time would be 75 seconds and Rₚ would be 0.2 (15 divided by 75). Frᵥ is the frame rate of the played video. Ofr is an optimal frame rate. A constant value for Ofr may be used (e.g., 30) or Ofr may be determined as a function of Brᵥ.

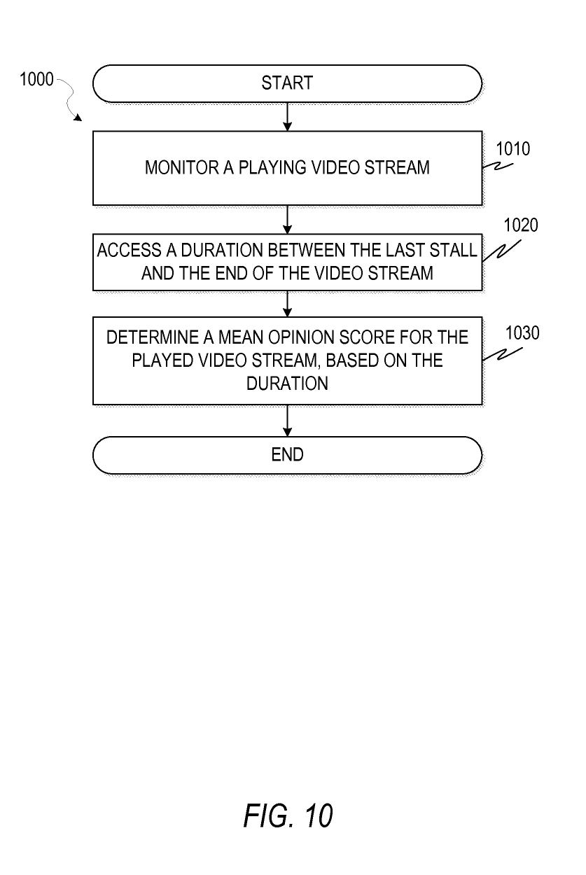

FIG. 10 is a flow diagram illustrating operations of a computer system implementing a process 1000 suitable for generating a video MOS using a parametric quality of experience model, according to some example embodiments. By way of example and not limitation, the operations of the method 1000 are described as being performed by the modules of FIG. 2. In operation 1010, the monitor module 210 monitors a playing video stream, as previously discussed.

In operation 1020, the evaluation module 220 accesses a duration between a last stall and the end of the video stream. For example, if two stalls occur in a one-minute video, the first ending 20 seconds into the video and the second ending 35 seconds into the video, the duration is 25 seconds, since 25 seconds of uninterrupted video played after the end of the last stall. For the purpose of this operation, when no stalls occur, the duration may be considered to be the full length of the video stream.

In operation 1030, the evaluation module 220 determines a MOS for the received video stream, based on the duration. In some example embodiments, the MOS score is generated using an equation of the form:

$${I}_{mf} = \frac{{v}_{18}}{{R}_{F}} {( {t}_{play} )}^{\frac{1}{{v}_{20}}} \qquad ( 18 )$$

In the above equation, I_{mf} is the score derived from the duration of the last stall-free playback. v₁₈ and v₂₀ are parameters of the model. R_{F} is the stall frequency discussed above with respect to operation 840. t_{play} is the duration of the last stall-free playback.

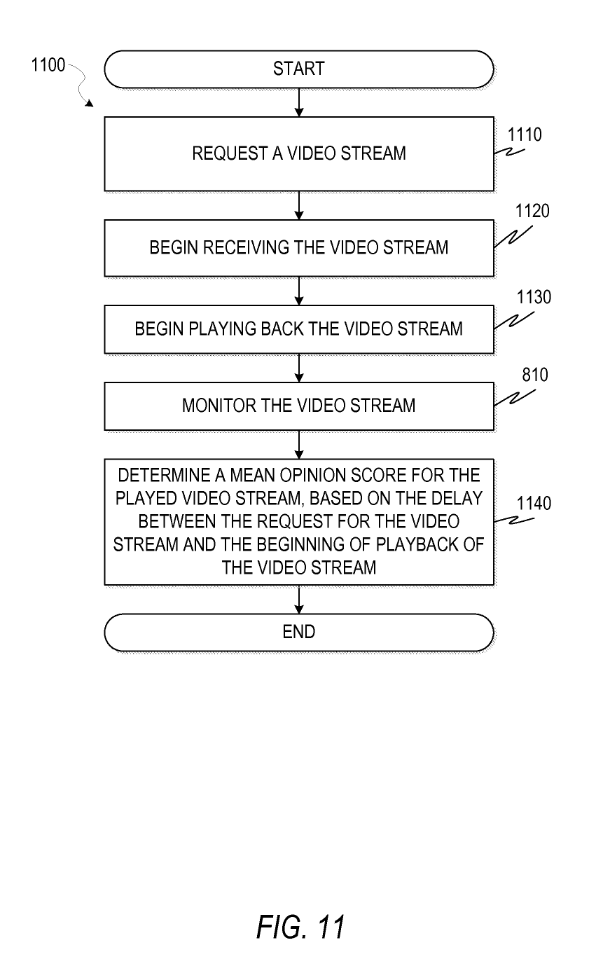

FIG. 11 is a flow diagram illustrating operations of a computer system implementing a process 1100 suitable for generating a video mean opinion score using a parametric quality of experience model, according to some example embodiments. By way of example and not limitation, the operations of the method 1100 are described as being performed by the client device 110 and the modules of FIG. 2.

The client device 110 requests a video stream in operation 1110. For example, the user 106 may use the web client 112 to access a video stream provided by the video system 142 for playback in a web browser of the client device 110. In operation 1120, the client device 110 begins receiving the video stream. The client device 110 begins playing back the video stream in operation 1130.

In operation 1140, the evaluation module 220 determines an MOS for the received video stream based on a delay between the request for the video stream and the beginning of playback of the video stream. In some example embodiments, the equations below are used.

$$\begin{matrix}{I}_{IB} = {e}^{- λ ( {T}_{IB} - {T}_{IB 0} )} + {V}_{r} & ( 19 ) \\ λ = {v}_{12} + {v}_{13} {Br}_{v} & ( 20 ) \\ {V}_{r} = F ( {v}_{14} + {v}_{15} {Br}_{v} ) & ( 21 ) \\ {T}_{IB 0} = \frac{log ( 1 - {V}_{r} )}{λ} & ( 22 )\end{matrix}$$

In the above equations, I_{IB} is the score derived from the initial buffer delay. v₁₂, v₁₃, v₁₄, and v₁₅ are parameters of the model. R_{F} and F are discussed above with respect to operation 840. Brᵥ is the bit rate of the original source video. T_{IB} is the duration of the delay between when the video was requested and when playback began.

In various example embodiments, the MOS score is generated using different combinations of the factors addressed above with respect to processes 800-1100. For example, each of the factors described above may be combined using the equation below:

VMOS=I_{mf}+I_{Ofr}I_{rebuf}I_{RF}I_{IB}I_{FR} (23)

In some example embodiments, the specific parameter values below are used. All values are unitless.

TABLE 1

| Parameter | Value |
|---|---|
| v₁ | 4.0 |
| v₂ | 48.8314 |
| v₃ | 0.9760 |
| v₄ | 0.0695 |
| v₅ | 0.0003 |
| v₆ | 0.1662 |
| v₇ | 0.0026 |
| v₈ | 0.655 |
| v₉ | 0 |
| v₁₀ | 0.2242 |
| v₁₁ | 0.0015 |
| v₁₂ | 0.0221 |
| v₁₃ | −1.2 × 10⁻¹² |
| v₁₄ | 0 |
| v₁₅ | 0 |
| D_{Frv} | 1.0457 |
| v₁₈ | 0.99 |
| v₂₀ | 2.718281828^{2.5} |

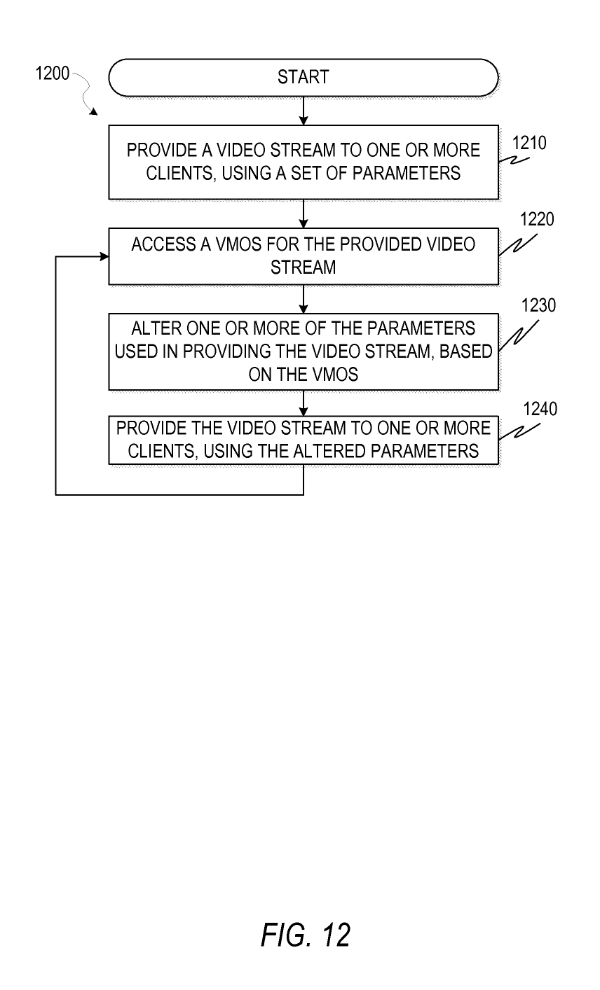

FIG. 12 is a flow diagram illustrating operations of a computer system implementing a process 1200 suitable for utilizing a video MOS, according to some example embodiments. By way of example and not limitation, the process 1200 is described as being performed by the video system 142 and monitoring system 144 of the application server 140 of FIG. 1

In operation 1210, the video system 142 provides a video stream to one or more client devices 110 using a set of parameters. For example, the video stream may contain a pre-recorded video, a live video event, or any suitable combination thereof. The parameters may include a buffer size, a bandwidth allocation, a bit rate, a frame rate, a priority, or any suitable combination thereof.

In operation 1220, the monitoring system 144 accesses a VMOS for the provided video stream. The VMOS may be generated by the monitoring system 144, generated by the client devices 110, generated by the third-party server 130, or any suitable combination thereof. The accessed VMOS may be the average of a VMOS score generated for each receiving client device 110.

In operation 1230, the video system 142 alters one or more of the parameters used in providing the video stream, based on the VMOS and its components. For example, if the VMOS score falls below a threshold, a determination may be made to alter parameters in an attempt to improve the perceived video quality. In some example embodiments, the components of the VMOS score are analyzed to determine possible improvements. For example, if the I_{rebuf} and I_{RF} factors are low due to rebuffering events, the video system 142 may increase the buffer size, so long as the projected decrease in VMOS due to the I_{IB} factor (which depends on the time taken to initially fill the buffer) is less than a projected increase in VMOS due to having fewer rebuffering events. In other example embodiments, the VMOS scores may be used by service providers in order to provide an assessment of the video quality experienced by their users.

In operation 1240, the video system 142 provides a video stream to one or more clients (the same clients as in operation 1210, different clients from those in operation 1210, or any suitable combination thereof), using the altered parameters. The video stream may be the same video stream as that provided in operation 1210 or a different video stream. The parameters may be set on a per-video basis, a per-user basis, a per-provider basis, a per-device basis, or any suitable combination thereof. For example, a video using a variable-bit-rate encoding may use different parameters than another video using a fixed-bit-rate encoding.

### Modules, Components, and Logic

Certain embodiments are described herein as including logic or a number of components, modules, or mechanisms. Modules may constitute hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-12 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

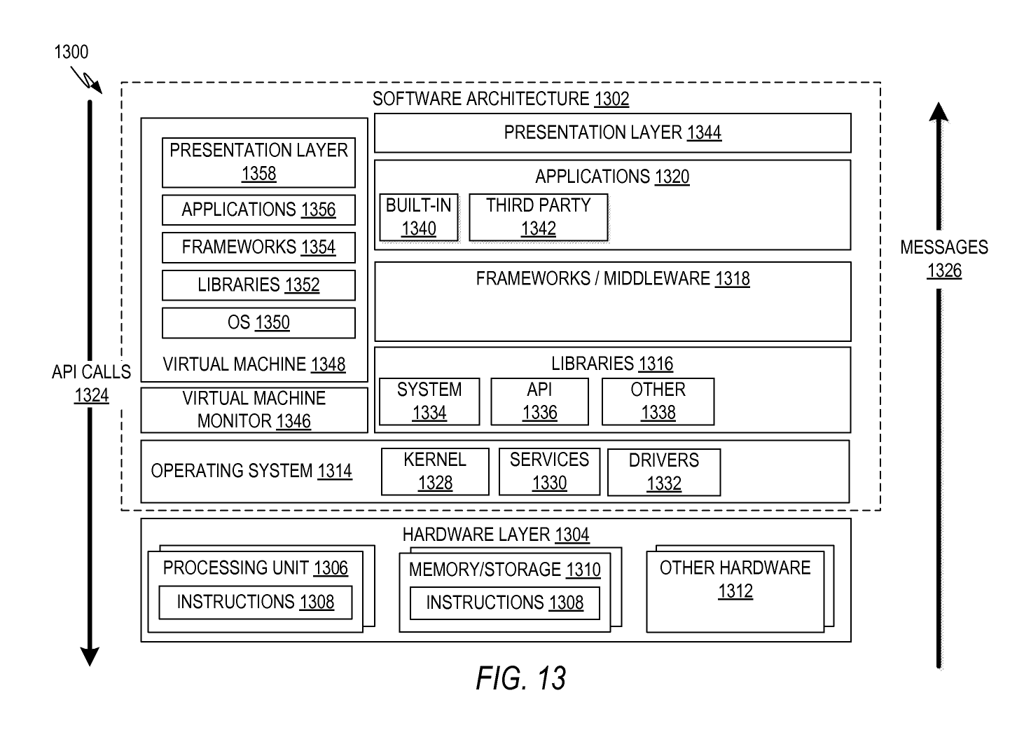

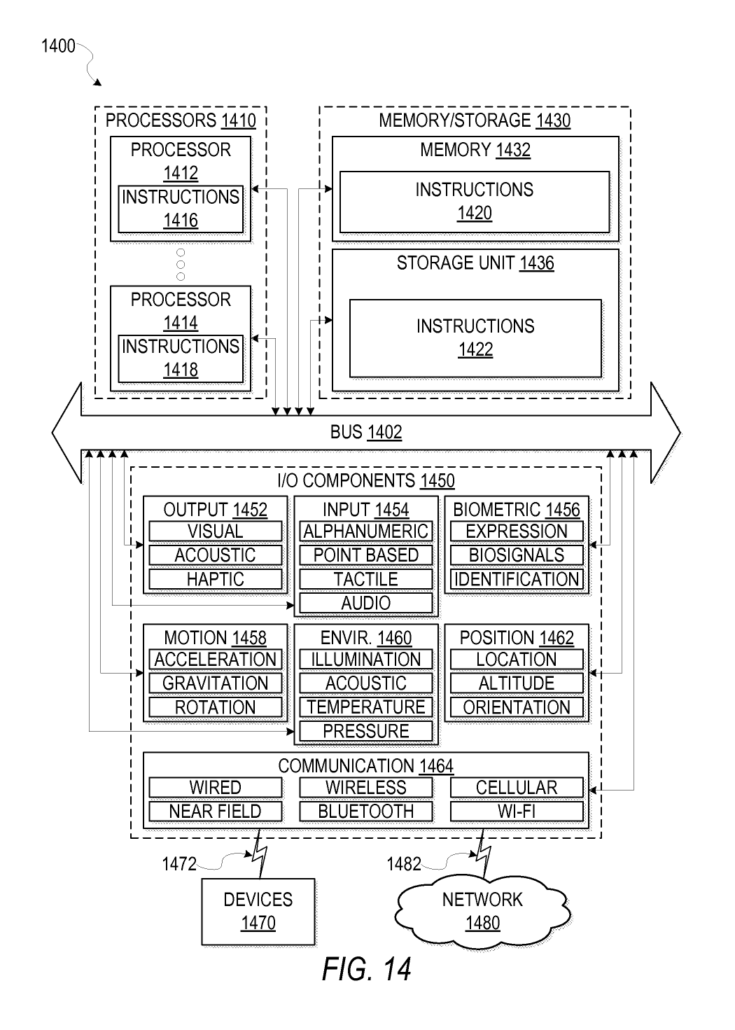

FIG. 13 is a block diagram 1300 illustrating a representative software architecture 1302, which may be used in conjunction with various hardware architectures herein described. FIG. 13 is merely a non-limiting example of a software architecture and it will be appreciated that many other architectures may be implemented to facilitate the functionality described herein. The software architecture 1302 may be executing on hardware such as machine 1400 of FIG. 14 that includes, among other things, processors 1410, memory 1430, and input/output (I/O) components 1450. A representative hardware layer 1304 is illustrated and can represent, for example, the machine 1400 of FIG. 14. The representative hardware layer 1304 comprises one or more processing units 1306 having associated executable instructions 1308. Executable instructions 1308 represent the executable instructions of the software architecture 1302, including implementation of the methods, modules and so forth of FIGS. 1-12. Hardware layer 1304 also includes one or more memory or storage modules 1310, which also have executable instructions 1308. Hardware layer 1304 may also comprise other hardware as indicated by 1312, which represents any other hardware of the hardware layer 1304, such as the other hardware illustrated as part of machine 1400.

In the example architecture of FIG. 13, the software 1302 may be conceptualized as a stack of layers where each layer provides particular functionality. For example, the software 1302 may include layers such as an operating system 1314, libraries 1316, frameworks/middleware 1318, applications 1320, and presentation layer 1344. Operationally, the applications 1320 or other components within the layers may invoke API calls 1324 through the software stack and receive a response, returned values, and so forth illustrated as messages 1326 in response to the API calls 1324. The layers illustrated are representative in nature and not all software architectures have all layers. For example, some mobile or special purpose operating systems may not provide a frameworks/middleware layer 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1316 may provide a common infrastructure that may be utilized by the applications 1320 or other components or layers. The libraries 1316 typically provide functionality that allows other software modules to perform tasks in an easier fashion than to interface directly with the underlying operating system 1314 functionality (e.g., kernel 1328, services 1330 or drivers 1332). The libraries 1316 may include system libraries 1334 (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D content in a graphics context on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The frameworks 1318 (also sometimes referred to as middleware) may provide a higher-level common infrastructure that may be utilized by the applications 1320 or other software components/modules. For example, the frameworks 1318 may provide various graphic user interface (GUI) functions, video functions, high-level resource management, high-level location services, and so forth. The frameworks 1318 may provide a broad spectrum of other APIs that may be utilized by the applications 1320 or other software components/modules, some of which may be specific to a particular operating system or platform.

The applications 1320 include built-in applications 1340 or third party applications 1342. Examples of representative built-in applications 1340 include, but are not limited to, a contacts application, a browser application, a book reader application, a location application, a media application, a messaging application, or a game application. Third party applications 1342 may include any of the built in applications as well as a broad assortment of other applications. In a specific example, the third party application 1342 (e.g., an application developed using the Android™ or iOS™ software development kit (SDK) by an entity other than the vendor of the particular platform) is mobile software running on a mobile operating system such as iOS™, Android™, Windows® Phone, or other mobile operating systems. In this example, the third party application 1342 invokes the API calls 1324 provided by the mobile operating system such as operating system 1314 to facilitate functionality described herein. The monitor module 210, evaluation module 220, and communication module 230 of the monitoring application 114 may be implemented as one or more third party applications 1342.

The applications 1320 may utilize built in operating system functions (e.g., kernel 1328, services 1330 and/or drivers 1332), libraries (e.g., system 1334, APIs 1336, and other libraries 1338), and frameworks/middleware 1318 to create user interfaces to interact with users of the system. Alternatively, or additionally, in some systems, interactions with a user may occur through a presentation layer, such as presentation layer 1344. In these systems, the application/module “logic” can be separated from the aspects of the application/module that interact with a user.

Some software architectures utilize virtual machines. In the example of FIG. 13, this is illustrated by virtual machine 1348. A virtual machine creates a software environment where applications/modules can execute as if they were executing on a hardware machine (e.g., such as the machine of FIG. 14). A virtual machine is hosted by a host operating system (e.g., operating system 1314 in FIG. 13) and typically, although not always, has a virtual machine monitor 1346, which manages the operation of the virtual machine as well as the interface with the host operating system (e.g., operating system 1314). A software architecture executes within the virtual machine such as an operating system 1350, libraries 1352, frameworks/middleware 1354, applications 1356, or presentation layer 1358. These layers of software architecture executing within the virtual machine 1348 can be the same as corresponding layers previously described or may be different.

### Example Machine Architecture and Machine-Readable Medium

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1416-1422 (e.g., software, a program, an application, an applet, an app, or other executable code) for causing the machine 1400 to perform any one or more of the methodologies discussed herein may be executed. For example the instructions may cause the machine to execute the flow diagrams of FIGS. 8-12. Additionally or alternatively, the instructions may implement the monitor module 210, the evaluation module 220, and the communication module 230 of FIG. 2, the video system 142 and monitoring system 144 of FIG. 1, or both. The instructions transform the general, non-programmed machine into a particular machine programmed to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but is not limited to, a server computer, a client computer, a personal computer (PC), or any machine capable of executing the instructions 1416-1422, sequentially or otherwise, that specify actions to be taken by machine 1400. Further, while only a single machine 1400 is illustrated, the term “machine” shall also be taken to include a collection of machines 1400 that individually or jointly execute the instructions 1416-1422 to perform any one or more of the methodologies discussed herein.

The machine 1400 may include processors 1410, memory 1430, and I/O components 1450, which may be configured to communicate with each other such as via a bus 1402. In an example embodiment, the processors 1410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 1412 and processor 1414 that may execute instructions 1416 and instructions 1418, respectively. The term “processor” is intended to include multi-core processors that comprise two or more independent processors (sometimes referred to as “cores”) that may execute instructions contemporaneously. Although FIG. 14 shows multiple processors, the machine 1400 may include a single processor with a single core, a single processor with multiple cores, multiple processors with a single core, multiple processors with multiples cores, or any combination thereof.

The memory/storage 1430 may include a memory 1432, such as a main memory, or other memory storage, and a storage unit 1436, each accessible to the processors 1410, such as via the bus 1402. The storage unit 1436 and memory 1432 store the instructions 1422 and the instructions 1420, respectively, embodying any one or more of the methodologies or functions described herein. Instructions, e.g., instructions 1416-1422, may also reside, completely or partially, within the memory 1432, within the storage unit 1436, within at least one of the processors 1410 (e.g., within the processor's cache memory), or any suitable combination thereof, during execution thereof by the machine 1400. Accordingly, the memory 1432, the storage unit 1436, and the memory of processors 1410 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., instructions 1416-1422) for execution by a machine (e.g., machine 1400), such that the instructions, when executed by one or more processors of the machine 1400 (e.g., processors 1410), cause the machine 1400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1450 may include a wide variety of components to receive input, provide output, produce output, transmit information, exchange information, capture measurements, and so on. The specific I/O components 1450 that are included in a particular machine will depend on the type of machine. For example, portable machines such as mobile phones will likely include a touch input device or other such input mechanisms, while a headless server machine will likely not include such a touch input device. It will be appreciated that the I/O components 1450 may include many other components that are not shown in FIG. 14. The I/O components 1450 are grouped according to functionality merely for simplifying the following discussion and the grouping is in no way limiting. In various example embodiments, the I/O components 1450 may include output components 1452 and input components 1454. The output components 1452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example embodiments, the I/O components 1450 may include biometric components 1456, motion components 1458, environmental components 1460, or position components 1462 among a wide array of other components. For example, the biometric components 1456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1458 may include acceleration sensor components (e.g., accelerometer), gravitation sensor components, rotation sensor components (e.g., gyroscope), and so forth. The environmental components 1460 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 or devices 1470 via coupling 1482 and coupling 1472, respectively. For example, the communication components 1464 may include a network interface component or other suitable device to interface with the network 1480. In further examples, communication components 1464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1470 may be another machine or any of a wide variety of peripheral devices (e.g., a peripheral device coupled via a USB).

Moreover, the communication components 1464 may detect identifiers or include components operable to detect identifiers. For example, the communication components 1464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Code Council Reduced Space Symbology codes (e.g., UCC RSS-2D bar code), and other optical codes), or acoustic detection components (e.g., microphones to identify tagged audio signals). In addition, a variety of information may be derived via the communication components 1464, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1480 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1480 or a portion of the network 1480 may include a wireless or cellular network and the coupling 1482 may be a Code Division Multiple Access (CDMA) connection, a Global System for Mobile communications (GSM) connection, or other type of cellular or wireless coupling. In this example, the coupling 1482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1416-1422 may be transmitted or received over the network 1480 using a transmission medium via a network interface device (e.g., a network interface component included in the communication components 1464) and utilizing any one of a number of well-known transfer protocols (e.g., hypertext transfer protocol (HTTP)). Similarly, the instructions 1416-1422 may be transmitted or received using a transmission medium via the coupling 1472 (e.g., a peer-to-peer coupling) to devices 1470. The term “transmission medium” shall be taken to include any intangible medium that is capable of storing, encoding, or carrying instructions for execution by the machine 1400, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
playing at a device, over a first time period, a video stream having a bit rate;
determining a count of stalls in the playing of the video stream;
determining, based on the count of stalls and the bit rate, a score for the video stream; and
providing, to a server device, the score.

2. The method of claim 1, wherein each stall comprises a second time period in which playback is halted, with the method further comprising:
determining a total duration of the second time periods;
wherein the determining of the score for the video stream is further based on the total duration of the second time periods.

3. The method of claim 2, wherein the determining of the score for the video stream is further based on a ratio of the total duration of the second time periods to the first time period.

4. The method of claim 2, wherein playback is halted for each stall due to an amount of video data for the video stream stored in a buffer falling below a threshold.

5. The method of claim 2, wherein playback is halted for each stall due to a rate of received data for the video stream falling below a threshold.

6. The method of claim 1, further comprising determining an amount of time between an end of a last stall and an end of the video stream; and
wherein the determining of the score for the video stream is further based on the amount of time between the end of the last stall and the end of the video stream.

7. The method of claim 6, wherein:
the determining of the score determines the score based on a sum of a plurality of components;
a first component of the plurality of components being based on the amount of time between the end of the last stall and the end of the video stream;
a second component of the plurality of components being based on a product of a plurality of sub-components;
a first sub-component of the plurality of sub-components being based on the count of stalls; and
a second sub-component of the plurality of sub-components being based on the bit rate.

8. The method of claim 1, further comprising:
requesting the video stream;
playing the video stream on a display; and
determining an initial delay, the initial delay being based on an amount of time between the requesting of the video stream and the playing of the video stream; and
wherein the determining of the score for the video stream is further based on the initial delay.

9. The method of claim 8, further comprising determining an acceptable initial delay; and
wherein the determining of the score for the video stream based on the initial delay determines the score for the video stream based on a difference between the initial delay and the acceptable initial delay.

10. The method of claim 1, further comprising:
determining a frame rate of the video stream; and
wherein the determining of the score for the video stream is further based on the frame rate of the video stream.

11. The method of claim 1, further comprising:
determining a rebuffering frequency, the rebuffering frequency being based on a ratio between the count of stalls and the first time period; and
wherein the determining of the score for the video stream is further based on the rebuffering frequency.

12. The method of claim 11, further comprising:
determining an acceptable rebuffering frequency; and
wherein the determining of the score for the video stream based on the rebuffering frequency determines the score for the video stream based on a difference between the rebuffering frequency and the acceptable rebuffering frequency.

13. A system comprising:
a memory storing instructions; and
a processor coupled to the memory, wherein when the processor executes the instructions, the processor performs operations comprising:
monitoring play, over a first time period, of a video stream having a bit rate;
determining a count of stalls in the playing of the video stream;
determining, based on the count of stalls and the bit rate, a score for the video stream; and
providing, to a device, the score.

14. The system of claim 13, wherein each stall comprises a second time period in which playback is halted, and wherein the operations further comprise:
determining a total duration of the second time periods; and
determining the score for the video stream based on the total duration of the second time periods.

15. The system of claim 14, wherein the determining of the score for the video stream is further based on a ratio of the total duration of the second time periods to the first time period.

16. The system of claim 13, wherein the operations further comprise determining an amount of time between an end of a last stall and an end of the video stream; and
wherein the determining of the score for the video stream is further based on the amount of time between the end of the last stall and the end of the video stream.

17. The system of claim 16, wherein:
the determining of the score determines the mean opinion score based on a sum of a plurality of components;
a first component of the plurality of components being based on the amount of time between the end of the last stall and the end of the video stream;
a second component of the plurality of components being based on a product of a plurality of sub-components;
a first sub-component of the plurality of sub-components being based on the count of stalls; and
a second sub-component of the plurality of sub-components being based on the bit rate.

18. The system of claim 13, wherein the system further comprises a display, and the operations further comprise:
requesting the video stream;
playing the video stream on the display;
determining an initial delay, the initial delay being based on an amount of time between the requesting of the video stream and the playing of the video stream; and
wherein the determining of the score for the video stream is further based on the initial delay.

19. The system of claim 18, wherein the operations further comprise determining an acceptable initial delay; and
wherein the determining of the score for the video stream based on the initial delay determines the score for the video stream based on a difference between the initial delay and the acceptable initial delay.

20. A computer program product comprising computer executable instructions stored on a non-transitory computer-readable medium that, when executed by a processor, cause the processor to perform operations comprising:
playing, over a first time period, a video stream having a bit rate;
determining a count of stalls in the playing of the video stream;
determining, based on the count of stalls and the bit rate, a score for the video stream; and
providing, to a server device, the score.
